(19) United States
(12) Patent Application Publication
(10) Pub. No.: US 2016/0236772 A1
(43) Pub. Date: Aug. 18, 2016

(54) AERIAL VEHICLE

(71) Applicant: HON HAI PRECISION INDUSTRY CO., LTD., New Taipei (TW)

(72) Inventor: PEI-CHONG TANG, New Taipei (TW)

(21) Appl. No.: 14/751,893

(22) Filed: Jun. 26, 2015

(30) Foreign Application Priority Data
Feb. 13, 2015 (CN) 201510077293.8

(51) Int. Cl. B64C 25/52; B64C 27/08; B64C 39/02

(52) U.S. Cl. CPC B64C 25/52; B64C 39/024; B64C 27/08; B64C 2025/325

(57) ABSTRACT

An aerial vehicle includes a body including a bottom portion, a plurality of rotors coupled to the body for driving the aerial vehicle to fly, and a landing gear coupled to the bottom portion of the body. The landing gear can include a first touchdown bar and a second touchdown bar. The first touchdown bar has a bottom face for contacting a horizontal plane. The second touchdown bar has a bottom face for contacting the horizontal plane. The bottom face of the first touchdown bar and the bottom face of the second touchdown bar cooperatively define a plane. When the aerial vehicle is in flight, the plane is at an angle relative to the horizontal plane. When the aerial vehicle is landing at the horizontal plane, the plane is parallel to the horizontal plane, the body is angled relative to the horizontal plane.

### FIELD

The subject matter herein generally relates to aerial vehicles, particularly relates to a helicopter rotor type aerial vehicle.

### BACKGROUND

Unmanned aerial vehicles are used for aerial photography, atmospheric observations, military reconnaissance, danger detections and other fields. The aerial vehicle controls its flight altitude by controlling rotation speed of a plurality of rotors thereof. The aerial vehicle can be a quad-rotor aerial vehicle, a six-rotor aerial vehicle, an eight-rotor aerial vehicle, or others. The rotors are mounted on a vertical mechanism to provide vertical lift to the aerial vehicle. The aerial vehicle generally includes a landing gear for supporting the aerial vehicle during takeoff and landing.

### BRIEF DESCRIPTION OF THE DRAWINGS

Implementations of the present technology will now be described, by way of example only, with reference to the attached figures.

FIG. 1 is an isometric view of an aerial vehicle in accordance with an embodiment of the present disclosure.

FIG. 2 is a diagrammatic view of the aerial vehicle in FIG. 1 in level flight.

FIG. 3 is a diagrammatic view of the aerial vehicle in FIG. 1 landing at a horizontal plane.

FIG. 4 is an isometric view of an aerial vehicle in accordance with another embodiment of the present disclosure.

FIG. 5 is a diagrammatic view of the aerial vehicle in FIG. 4 in level flight.

FIG. 6 is a diagrammatic view of the aerial vehicle in FIG. 4 landing at a horizontal plane.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to an aerial vehicle. The aerial vehicle can include a body including a bottom portion, a plurality of rotors coupled to the body for driving the aerial vehicle to fly, and a landing gear coupled to the bottom portion of the body. The landing gear can include a first touchdown bar and a second touchdown bar. The first touchdown bar has a bottom face for contacting a horizontal plane. The second touchdown bar has a bottom face for contacting the horizontal plane. The bottom face of the first touchdown bar and the bottom face of the second touchdown bar cooperatively define a plane. When the aerial vehicle is in flight, the plane defined by the bottom face of the first touchdown bar and the bottom face of the second touchdown bar is at an angle relative to the horizontal plane. When the aerial vehicle is landing at the horizontal plane, the plane defined by the bottom face of the first touchdown bar and the bottom face of the second touchdown bar is parallel to the horizontal plane, and the body is angled relative to the horizontal plane.

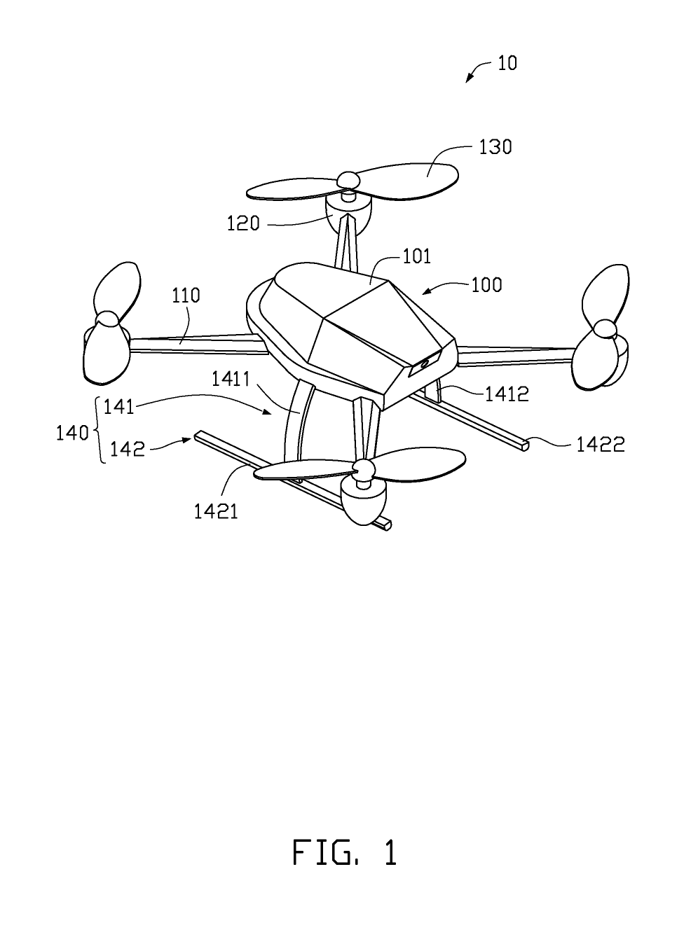

FIG. 1 illustrates an aerial vehicle 10 of an embodiment of the present disclosure. The aerial vehicle 10 can include a body 100, a plurality of arms 110 coupled to the body 100, a plurality of rotors 130 coupled to the arms 110, a plurality of driving devices 120 coupled to the rotors 130, a control module coupled to the body 100, and a landing gear 140 coupled to the body 100.

In this embodiment, the aerial vehicle 10 is shown as a quad-rotor aerial vehicle, just for taking an example for illustrating a configuration of the aerial vehicle, the aerial vehicle also can be a six-rotor aerial vehicle, an eight-rotor aerial vehicle, or others. In this embodiment, the aerial vehicle includes four arms 110, four rotors 130 and four driving devices 120. The four arms 110 extend outwardly from the body 100. The four arms 110 can be located at a horizontal plane. The four arms 110 can be symmetrical to each other about the body 100. The four rotors 130 and the four driving devices 120 are mounted to the four arms 110. The controlling module is mounted in the body 100, the controlling module can include a controller and a balance control system. The landing gear 140 is mounted below the body 100 and configured to support the aerial vehicle 10 when the aerial vehicle 10 is takeoff and landing.

The body 100 can include a ceiling portion 101, a bottom portion 102 opposite to the ceiling portion 101 and a lateral portion 103 connecting the ceiling portion 101 and the bottom portion 102. The four arms 110 extend outwards from the lateral portion 103. The four driving devices 120 are mounted at distal ends of the arms 110, respectively. The four rotors 130 are located above and connecting the four driving devices 120, respectively. Each rotor 130 can be independently controlled by a corresponding driving device 120. The driving device 120 is configured to provide power to drive the corresponding rotor 130 to rotate to produce vertical lift to drive the aerial vehicle 10 to fly. By adjusting rotation speeds of the rotors 130, the aerial vehicle 10 can realize flight attitudes of lifting, landing, level flight, level rotation, heeling, hovering and others.

In other embodiment, the number of the arms 110 can be six, eight or others, correspondingly, the number of the rotors 130 at the distal ends of the arms 110 can be six, eight or others. The aerial vehicles with these numbers of arms 110 and rotors 130 have working principle substantially same as that of the aerial vehicle 10 with four arms 110 and four rotors 130.

The balance control system is configured to collecting balance information of the body 100 and transmits the balance information to the controller. According to the balance information, the controller calculates driving power for maintaining stationary state of the body 100, and transmits the value of the calculated driving power to the driving device 120, the driving device 120 outputs appropriate drive power to adjust rotation speed of the corresponding rotor 130. The balance control system can include a gyroscope, accelerator and a magnetic compass. The gyroscope is configured to measure angular velocity of the body 100, for control the rotation speed of the body 100 in flight. The accelerator is configured to measure accelerated velocity of the body 100 in flight for stabling balance of the body 100. The magnetic compass is configured to measure geomagnetic angle for marking nose direction of the aerial vehicle 10.

The landing gear 140 has a bottom defining a landing plane. The landing gear 140 can include a support configuration 141 and a touchdown configuration 142 coupled to the support configuration 141. The support configuration 141 can include a first support pole 1411 extending from the bottom portion 102 and a second support pole 1412 extending from the bottom portion 102. The touchdown configuration 142 can include a first touchdown bar 1421 coupled to the first support pole 1411, and a second touchdown bar 1422 coupled to the second support pole 1412. Bottoms of the first touchdown bar 1421 and the second touchdown bar 1422 define the landing plane.

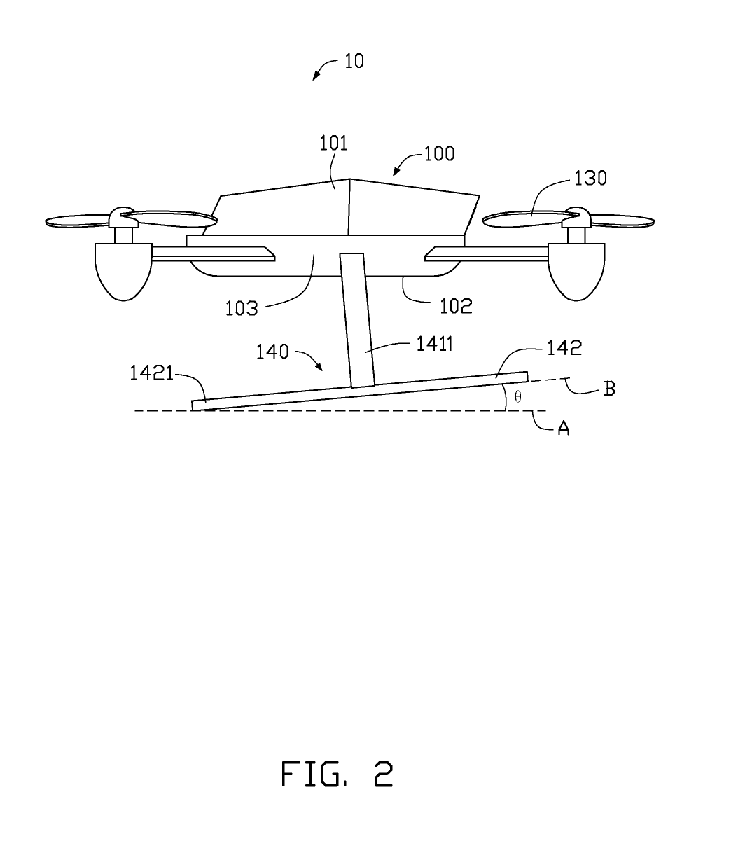

In at least an embodiment, the first support pole 1411 and the second support pole 1412 extend outwards and downwards from two sides of the bottom portion 102 at an angle. The first support pole 1411 and the second support pole 1412 are spaced to each other. The first support pole 1411 connects between the first touchdown bar 1421 and the bottom portion 102 of the body 100. The second support pole 1412 connects between the second touchdown bar 1421 and the bottom portion 102 of the body 100. The first support pole 1411 has a same length as that of the second support pole 1412. The first touchdown bar 1421 is parallel to the second touchdown bar 1422. The first touchdown bar 1421 has a bottom face for contacting a horizontal plane A or other faces. The second touchdown bar 1422 has a bottom face for contacting the horizontal plane A or other faces. The bottom faces of the first touchdown bar 1421 and the second touchdown bar 1422 are angled relative to the bottom portion 102 of the body 100. The bottom faces of the first touchdown bar 1421 and the second touchdown bar 1422 cooperatively define the landing plane: a plane B (shown in FIG. 2). The landing plane is angled relative to the bottom portion 102 of the body 100. Each of the first touchdown bar 1421 and the second touchdown bar 1422 has a first end and a second end opposite to the first end, a distance between the bottom face at the first end and the bottom portion 102 is larger than that between the bottom face at the second end and the bottom portion 102.

FIG. 2 illustrates that the aerial vehicle 10 is in level flight. In level flight, the body 100 is substantially parallel to the horizontal plane A. The bottom portion 102 of the body 100 is substantially parallel to the horizontal plane A. Each of the bottom faces of the first and second touchdown bars 1421, 1422 is angled relative to the horizontal plane A. The landing plane defined by the bottom faces of the first and second touchdown bars 1421, 1422 is at an angle relative to the horizontal plane A, the angle between the landing plane and the horizontal plane A is θ. That is to say, the bottom portion 102 and the landing plane defined by the bottom faces of the first and second touchdown bars 1421, 1422 define an angle θ therebetween. The lift provided by the rotors 130 is in the vertical direction.

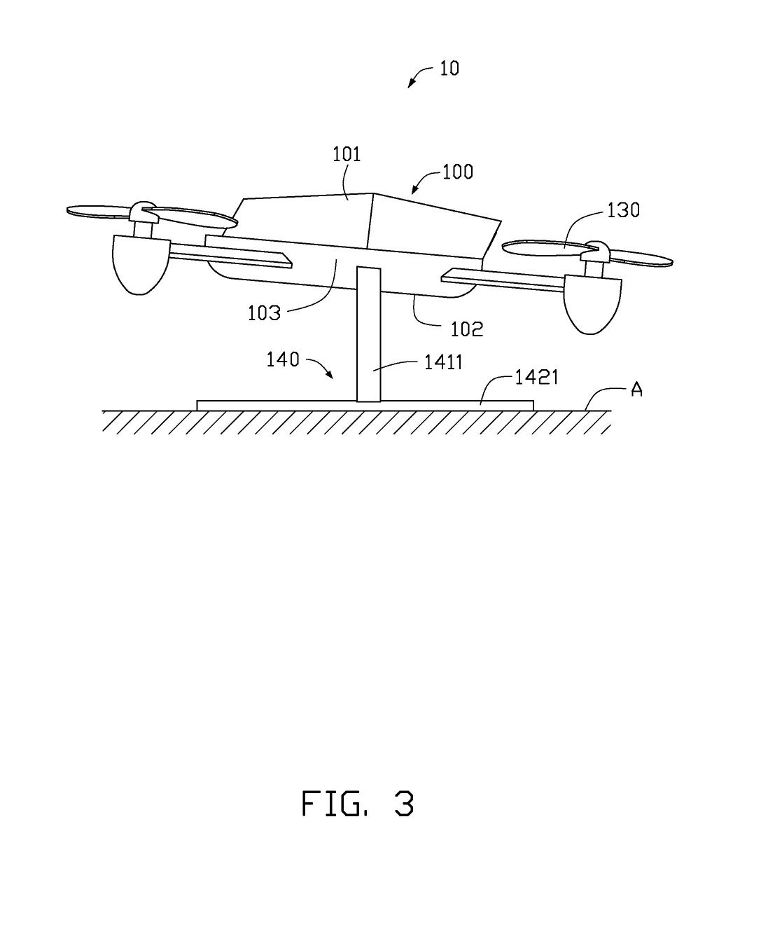

FIG. 3 illustrates that the aerial vehicle 10 is landing at a plane. The plane can be the horizontal plane A. The bottom faces of the first and second touchdown bars 1421, 1422 contact the horizontal plane A. The landing plane defined by the bottom faces of the first and second touchdown bars 1421, 1422 is at the horizontal plane A. The body 100 is angled relative to the horizontal plane A to define an angle substantially equal to the angle θ between the bottom portion 102 and the horizontal plane A. The lift provided by the rotors 130 is not in the vertical direction, but rather is angled relative to the vertical direction, such that the lift provided by the rotors 130 produces a component force in the horizontal direction and a component force in the vertical direction. When the component force in the vertical direction is less than the gravity of the aerial vehicle 10, the aerial vehicle 10 slides on the horizontal plane A under the component force in the horizontal direction.

In at least an embodiment, the angle θ is less than 15° to ensure the aerial vehicle 10 stably stand on the horizontal plane A. Perfectly, the angle θ is in a range from 10° to 15°, so that the body 100 is angled relative to the horizontal plane A with the angle therebetween in a range from 10° to 15°.

In at least an embodiment, the first touchdown bar 1421 is not limited to parallel to the second touchdown bar 1422, the first touchdown bar 1421 can be slant to the second touchdown bar 1422, so long as the first and second touchdown bars 1421, 1422 firmly stand on the horizontal plane A when the aerial vehicle 10 landing at the horizontal plane A.

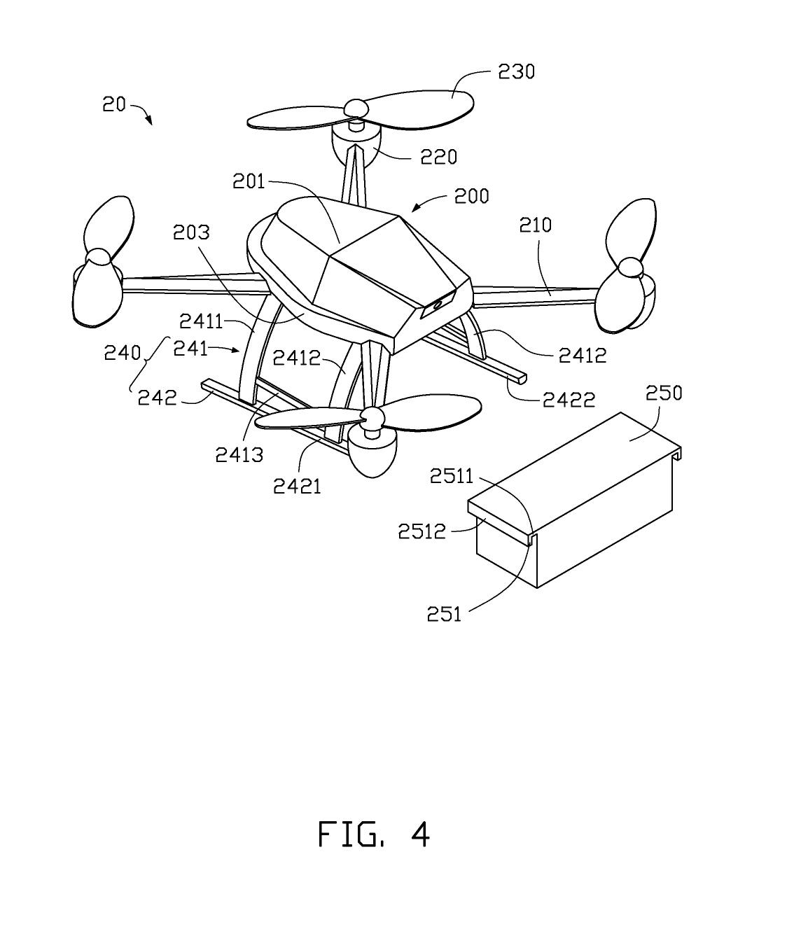

FIG. 4 illustrates an aerial vehicle 20 of another embodiment of the present disclosure. The aerial vehicle 20 can include a body 200, a plurality of arms 210 coupled to the body 200, a plurality of rotors 230 coupled to the arms 210, a plurality of driving devices 220 coupled to the rotors 230, a control module coupled to the body 200, a landing gear 240 coupled to the body 200, and a load case 250 configured to couple the landing gear 240.

In this embodiment, the aerial vehicle 20 is shown as a quad-rotor aerial vehicle, just for taking an example for illustrating a configuration of the aerial vehicle, the aerial vehicle also can be a six-rotor aerial vehicle, an eight-rotor aerial vehicle, or others. In this embodiment, the aerial vehicle 20 includes four arms 210, four rotors 230 and four driving devices 220. The four arms 210 extend outwardly from the body 200. The four arms 210 can be symmetrical to each other about the body 200. The four rotors 230 and the four driving devices 220 are mounted to the four arms 210. The controlling module is mounted in the body 200, the controlling module can include a controller and a balance control system. The landing gear 240 is mounted below the body 200 and configured to support the aerial vehicle 20 when the aerial vehicle 20 is takeoff and landing.

The body 200 can include a ceiling portion 201, a bottom portion 202 opposite to the ceiling portion 201 and a lateral portion 203 connecting the ceiling portion 201 and the bottom portion 202. The four arms 210 extend outwards from the lateral portion 203. The four arms 210 can be located at a horizontal plane. The four driving devices 220 are mounted at distal ends of the arms 210, respectively. The four rotors 230 is located above and connecting the four driving devices 220, respectively. Each rotor 230 can be independently controlled by a corresponding driving device 220. The driving device 220 is configured to provide power to drive the corresponding rotor 230 to rotate to produce vertical lift to drive the aerial vehicle 20 to fly. By adjusting rotation speeds of the rotors 230, the aerial vehicle 20 can realize flight attitudes of lifting, landing, level flight, level rotation, heeling, hovering and others.

In other embodiment, the number of the arms 210 can be six, eight or others, correspondingly, the number of the rotors 230 at the distal ends of the arms 210 can be six, eight or others. The aerial vehicles with these numbers of arms 210 and rotors 230 have working principle substantially same as that of the aerial vehicle 20 with four arms 210 and four rotors 230.

The balance control system is configured to collecting balance information of the body 200 and transmits the balance information to the controller. According to the balance information, the controller calculates driving power for maintaining stationary state of the body 200, and transmits the value of the calculated driving power to the driving device 220, the driving device 220 outputs appropriate drive power to adjust rotation speed of the corresponding rotor 230. The balance control system can include a gyroscope, accelerator and a magnetic compass. The gyroscope is configured to measure angular velocity of the body 200, for control the rotation speed of the body 200 in flight. The accelerator is configured to measure accelerated velocity of the body 200 in flight for stabling balance of the body 200. The magnetic compass is configured to measure geomagnetic angle for marking nose direction of the aerial vehicle 20.

The landing gear 240 can include a support configuration 241 and a touchdown configuration 242 coupled to the support configuration 241. The support configuration 241 can include two first support poles 2411 extending from an end portion of the bottom portion 202 and two second support poles 2412 extending from another end portion of the bottom portion 202. The touchdown configuration 242 can include a first touchdown bar 2421 connecting one the two first support poles 2411 and a corresponding one of the two second support poles 2412, and a second touchdown bar 2422 connecting the other of the two first support poles 2411 and the other of the two second support poles 2412.

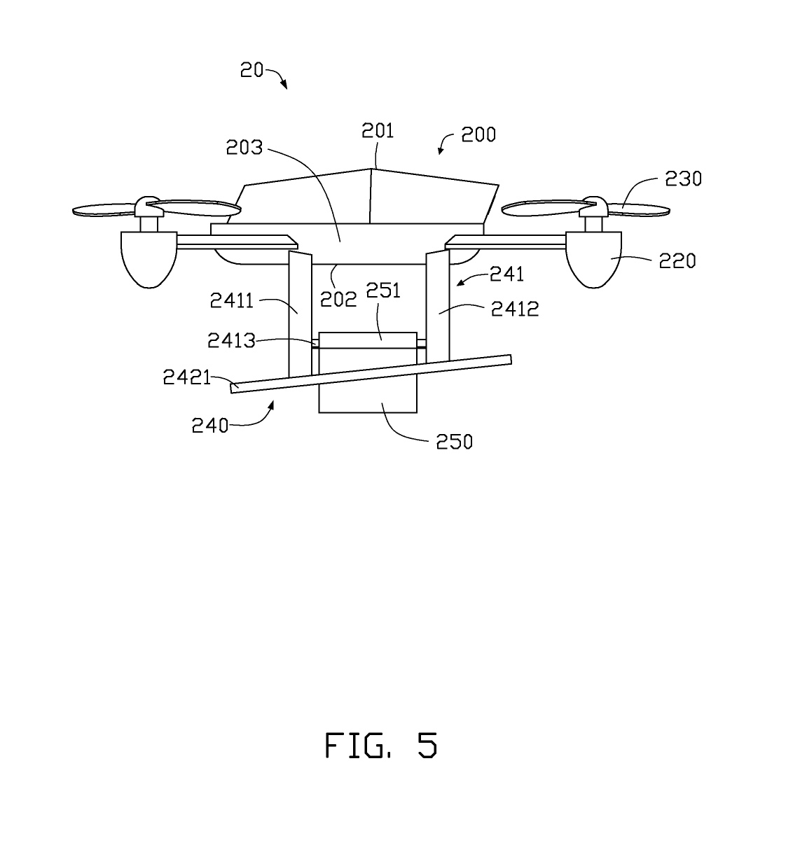

In at least an embodiment, the first support poles 2411 and the second support poles 2412 extend outwards and downwards from the two opposite end portions of the bottom portion 202 at an angle. The first support poles 2411 and the second supports pole 2412 are spaced to each other. Corresponding first support poles 2411 and second support poles 2412 connect between the first and second touchdown bars 2421, 2422 and the bottom portion 202 of the body 200. The first support pole 2411 and the second support pole 2412 connected by the first touchdown bar 1421 are parallel to each other. The first support pole 2411 and the second support pole 2412 connected by the second touchdown bar 1422 are parallel to each other. The two first support poles 2411 have the same length and the same height between the bottom portion 202 of the body 200 and the first and second touchdown bar 2421, 2422. The two second support poles 2412 have the same length and the same height between the bottom portion 202 of the body 200 and the first and second touchdown bar 2421, 2422. The first support pole 2411 has the length larger than the length of the second support pole 2412. The first and second touchdown bars 2421, 2422 are parallel to each other. The first touchdown bar 2421 has a bottom face for contacting a horizontal plane A or other faces. The second touchdown bar 2422 has a bottom face for contacting the horizontal plane A or other faces. The bottom faces of the first touchdown bar 1421 and the second touchdown bar 1422 are angled relative to the bottom portion 202 of the body 200. The bottom faces of the first touchdown bar 2421 and the second touchdown bar 2422 cooperatively define a plane B (shown in FIG. 5). The landing plane is angled relative to the bottom portion 202 of the body 200.

In at least one embodiment, a height of each first support pole 2411 between the bottom portion 202 of the body 200 and the bottom face of the first touchdown bar 2421 or the second touchdown bar 2422 is larger than a height of each second support pole 2412 between the bottom portion 202 of the body 200 and the bottom face of the first touchdown bar 2421 or the second touchdown bar 2422. Each of the first touchdown bar 2421 and the second touchdown bar 2422 has a first end and a second end opposite to the first end, a distance between the bottom face at the first end and the bottom portion 202 is larger than that between the bottom face at the second end and the bottom portion 202. The first support bars 2411 respectively connect the bottom portion 202 of the body 200 and corresponding first ends of the first touchdown bar 2421 and the second touchdown bar 2422. The second support bars 2412 respectively connect the bottom portion 202 of the body 200 and corresponding second ends of the first touchdown bar 2421 and the second touchdown bar 2422.

FIG. 5 illustrates that the aerial vehicle 20 is in level flight. In level flight, the body 200 is substantially parallel to a horizontal plane A (i.e., substantially horizontal). The bottom portion 202 of the body 200 is substantially parallel to the horizontal plane A. Each of the bottom faces of the first and second touchdown bars 2421, 2422 is angled relative to the horizontal plane A. The landing plane defined by the bottom faces of the first and second touchdown bars 2421, 2422 is at an angle relative to the horizontal plane A, the angle between the landing plane and plane A is θ. That is to say, the bottom portion 202 and the landing plane defined by the bottom faces of the first and second touchdown bars 2421, 2421 define an angle θ therebetween. The lift provided by the rotors 230 is in the vertical direction.

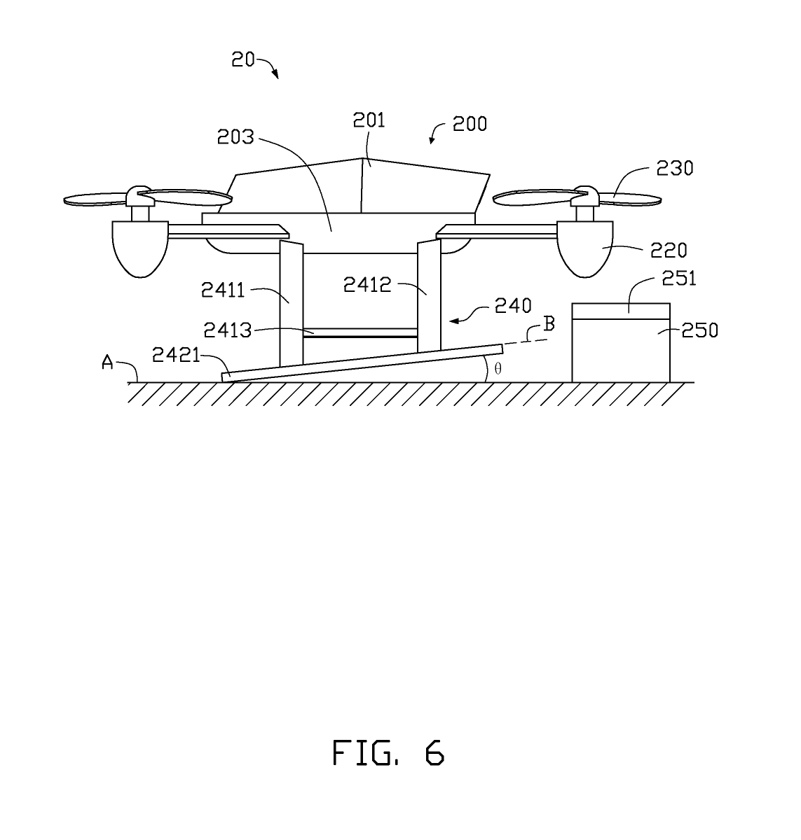

FIG. 6 illustrates that the aerial vehicle 20 is landing at a plane. The plane can be the horizontal plane A. The bottom faces of the first and second touchdown bar 2421, 2422 contact the horizontal plane A. The body 200 is angled relative to the horizontal plane A to define an angle substantially equal to the angle θ between the bottom portion 202 and the horizontal plane A. The lift provided by the rotors 230 is not in the vertical direction, the lift provided by the rotors 230 is angled relative to the vertical direction, the lift provided by the rotors 230 produces a component force in the horizontal direction and a component force in the vertical direction. When the component force in the vertical direction is less than the gravity of the aerial vehicle 20, the aerial vehicle 20 slides on the horizontal plane A under the component force in the horizontal direction.

In at least an embodiment, the angle θ is less than 15° to ensure the aerial vehicle 20 stably stand on the horizontal plane A. Perfectly, the angle θ is in a range from 10° to 15°, so that the body 200 is angled relative to the horizontal plane A with the angle therebetween in a range from 10° to 15°.

In at least an embodiment, the first touchdown bar 2421 is not limited to parallel to the second touchdown bar 2422, the first touchdown bar 2421 can be slant to the second touchdown bar 2422, so long as the first and second touchdown bars 2421, 2422 firmly stand on the horizontal plane A when the aerial vehicle 20 landing at the horizontal plane A.

In at least an embodiment, each of the first and the second support poles 2411, 2412 is arched outwardly. The landing gear 240 further include two positioning members 2413 connecting between corresponding first support poles 2411 and second support poles 2412. Each of the positioning members 2413 is a bar. The two positioning members 2413 are adjacent to corresponding first touchdown bar 2421 and second touchdown bar 2422. The two positioning members 2413 are angled relative to the first and second touchdown bars 2421, 2422. The two positioning members 2413 are parallel to each other and cooperatively define a plane parallel to the horizontal plane A. In at least an embodiment, the two positioning members 2413 can be replaced by four spaced positioning members respectively positioned to the first and second support poles 2411, 2412.

The load case 250 includes two clasps 251 opposite to each other and corresponding to the two positioning members 2413. Two opposite sidewalls of the load case 250 have upper portions thereof extending outwardly to form two top walls 2511, the two top walls 2511 extend downwards to form two blocking walls 2512. Corresponding top walls 2511, blocking walls 2512 and the sidewalls cooperatively form the two clasps 251.

When the aerial vehicle 20 is sliding on the horizontal plane A and moves to the load case 250, the first and second touchdown bars 2421, 2422 slide to opposite sides of the load case 250, the two clasps 251 of the load case 250 clasp the two positioning members 2413, thereby the load case 250 being coupled to the landing gear 240. The aerial vehicle 20 can takeoff and carry the load case 250 to destination. Therefore, the aerial vehicle 20 realizes automatically loading goods.

When the aerial vehicle 20 carrying the load case 250 is landing at the horizontal plane A, the load case 250 contacts the horizontal plane A, the control module adjusts flight height of the aerial vehicle 20 to detach the two clasps 251 from the two positioning members 2413, the aerial vehicle 20 slides away from the load case 250. Therefore, the aerial vehicle 20 realizes automatically offloading goods.

In this embodiment, the first touchdown bar 2421 and the second touchdown bar 2422 define a first distance L1 therebetween. The two first support pole 2411 have portions below the positing members 2413 define a second distance L2 therebetween, L2 can be variables. The two clasps 251 define a third distance L3 therebetween. The two opposite sidewalls of the load case 250 define a fourth distance L4 therebetween. The two positioning members 2413 define a fifth distance L5 therebetween. In at least an embodiment, a relationship between the first distance L1, the second distance L2, the third distance L3, the fourth distance L4 and the fifth distance L5 is L3>L5>L1>L4, L2 has part values larger than L3, so that, the first and second touchdown bars 2421, 2422 of the landing gear 240 can slide to opposite sides of the load case 250, and the two clasps 251 of the load case 250 can clasp the two positioning members 2413 of the landing gear 240.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An aerial vehicle comprising:
a body comprising a bottom portion;
a plurality of rotors coupled to the body for lifting and controlling direction of travel of the aerial vehicle to fly; and
a landing gear coupled to the bottom portion of the body, the landing gear comprising a first touchdown bar and a second touchdown bar, the first touchdown bar having a bottom face for contacting a horizontal plane, the second touchdown bar having a bottom face for contacting the horizontal plane, the bottom face of the first touchdown bar and the bottom face of the second touchdown bar cooperatively defining a plane angled relative to the bottom portion;
wherein, when the aerial vehicle is in flight, the plane defined by the bottom face of the first touchdown bar and the bottom face of the second touchdown bar is at an angle relative to the horizontal plane; and when the aerial vehicle is landing at the horizontal plane, the plane defined by the bottom face of the first touchdown bar and the bottom face of the second touchdown bar is parallel to the horizontal plane, the body is angled relative to the horizontal plane.

2. The aerial vehicle of claim 1, wherein the bottom face of the first touchdown bar is angled relative to the bottom portion of the body.

3. The aerial vehicle of claim 2, wherein the bottom face of the second touchdown bar is angled relative to the bottom portion of the body.

4. The aerial vehicle of claim 3, wherein the first touchdown bar is parallel to the second touchdown bar.

5. The aerial vehicle of claim 3, wherein the landing gear further comprises a first support pole connecting between the bottom portion of the body and the first touchdown bar, and a second support pole connecting between the bottom portion of body and the second touchdown bar.

6. The aerial vehicle of claim 5, wherein the first support pole has a length same as that of the second support pole.

7. The aerial vehicle of claim 3, wherein the landing gear further comprises two first support poles and two second support poles, the first touchdown bar connecting one corresponding first support pole and one corresponding second support pole, the second touchdown bar connecting the other corresponding first support pole and the other corresponding second support pole.

8. The aerial vehicle of claim 7, wherein the first support pole has a length larger than that of the second support pole.

9. The aerial vehicle of claim 8 further comprising a load case, wherein the load case comprises two clasps, the first support poles and the second support poles having positioning members configured to clasp the two clasps.

10. The aerial vehicle of claim 1, wherein the angle defined between the horizontal plane and the plane defined by the bottom face of the first touchdown bar and the bottom face of the second touchdown bar is less than 15°.

11. The aerial vehicle of claim 10, wherein the angle is in a range from 10° to 15°.

12. An aerial vehicle comprising:
a body comprising a bottom portion;
a plurality of rotors coupled to the body for driving the aerial vehicle to fly; and
a landing gear coupled to the bottom portion of the body, the landing gear comprising a first touchdown bar and a second touchdown bar, the first touchdown bar having a bottom face for contacting a horizontal plane, the second touchdown bar having a bottom face for contacting the horizontal plane, each of the first touchdown bar and the second touchdown bar having a first end and a second end opposite to the first end, a distance between the bottom portion and the bottom face at the first end being larger than that between the bottom portion and the bottom face at the second end.

13. The aerial vehicle of claim 12, wherein the bottom face of the first touchdown bar and the bottom face of the second touchdown bar cooperatively define a plane angled relative to the bottom portion of the body.

14. The aerial vehicle of claim 13, wherein when the aerial vehicle is in flight, the bottom portion of the body is parallel to the horizontal plane.

15. The aerial vehicle of claim 13, wherein when the aerial vehicle is landing at the horizontal plane, the bottom portion of the body is angled relative to the horizontal plane.

16. The aerial vehicle of claim 15, wherein the bottom portion of the body is angled relative to the horizontal plane with an angle less than 15°.

17. The aerial vehicle of claim 16, wherein the angle is in a range from 10° to 15°.

18. The aerial vehicle of claim 13, wherein the landing gear further comprises a plurality of support poles connecting between the bottom portion and the first touchdown bar and the second touchdown bar.

19. The aerial vehicle of claim 18 further comprising a load case, wherein the load case comprises two clasps, the support poles having positioning members configured to clasp the two clasps.

20. An aerial vehicle comprising:
a body;
a plurality of rotors coupled to the body configured to lift and control direction of travel of the aerial vehicle; and
landing gear coupled to body, the bottom of the landing gear defining a landing plane;
the body and the rotors defining a level plane that is substantially horizontal when the vehicle is in a state of level flight, the level plane being at an angle to the landing plane of 10-15 degrees;
wherein when the vehicle is on a surface the level plane is at the angle to the surface.
